(19) United States
(12) Patent Application Publication
(10) Pub. No.: US 2008/0276009 A1
(43) Pub. Date: Nov. 6, 2008

(54) Enabling Efficient Communication Between a Host and Multiple USB Devices

(76) Inventors: Joe Mesa, Irvine, CA (US); Charles F. Raasch, Lake Forest, CA (US)

Correspondence Address: PATENTMETRIX, 14252 CULVER DR. BOX 914, IRVINE, CA, 92604, US

(21) Appl. No.: 12/114,746

(22) Filed: May 3, 2008

Related U.S. Application Data
(60) Provisional application No. 60/915,949, filed on May 4, 2007.

(51) Int. Cl. G06F 3/00

(52) U.S. Cl. 710/4

(57) ABSTRACT

The present invention relates generally to devices and methods for communicating between a host computer and a peripheral device, such as a monitor or printer, and, more particularly, to enable efficient communication between a host and a plurality of such USB peripheral devices without substantial bandwidth degradation. In one embodiment, a device driver, in data communication with a configuration application executing on a host computer, instructs a secondary USB device to accept data packets related to not only its own unique address but also of at least one other primary USB device whose address was additionally caused to be stored with the USB device.

### CROSS-REFERENCE

The present application relies on for priority U.S. Provisional Application No. 60/915,949, entitled “Method for Enabling Efficient Communication Between A Host and Multiple USB Devices” filed May 4, 2007.

### FIELD OF THE INVENTION

The present invention relates generally to devices and methods for communicating between a host computer and a peripheral device such as a monitor or printer and, more particularly, to efficient communication between a host and a plurality of such USB peripheral devices without substantial bandwidth degradation.

### BACKGROUND OF THE INVENTION

The Universal Serial Bus (USB) is a cable bus that supports data exchange between a host computer and a wide range of simultaneously accessible peripheral devices. The attached peripheral devices share USB bandwidth through a host-scheduled, token-based protocol. The bus allows peripherals to be attached, configured, used, and detached while the host and other peripherals are in operation. The USB is defined by a specification that is approved by a committee of industry representatives. The specification covers all aspects of USB operation, including electrical, mechanical, and communications characteristics. To be called a USB device, a peripheral must conform to this specification.

The USB architecture defines a layered software scheme which includes, at the highest level, client drivers; at an intermediate level, USB system software; and at the lowest level, host controller software. Transactions performed over the USB are controlled by the client driver. The device (or hub client) may be class specific or vendor specific. Accordingly, each hub client requires a corresponding client driver which is tailored to the specific device class or device vendor. A client driver accesses its corresponding hub client by requesting an I/O transfer using an I/O request packet (IRP). System software allocates the necessary bandwidth for the transfer and directs the IRP to its destination hub client. The host controller software communicates with a USB host controller for the actual transmission of control and data information to and from the USB devices.

A Host identifies which downstream device it wishes to communicate with, via a unique device address. A device is assigned a unique address by the host during the enumeration process. As result of the unique addressing per USB device, if the PC host has the same data to send to several devices, the host must send the data to each device individually. This approach enables each device to independently acknowledge receipt of the packet, thereby enabling a reliable transport protocol. Unfortunately, this comes at a cost of bandwidth utilization, since the data is transmitted several times across the same medium. Therefore, if one host is communicating with multiple devices, such as multiple monitors, there can be substantial degradation across the various devices.

Accordingly there is a need for methods that would allow efficient communication between host and USB devices without bandwidth degradation resulting from the connection of multiple USB devices to a host. Further, there is a need for methods that would allow for a host to concurrently broadcast to multiple USB devices.

### SUMMARY OF THE INVENTION

It is an object of the present invention to provide a method of efficient communication between a host computer and a plurality of peripheral devices associated with the applications programs executing on the host computer.

It is another object of the present invention to provide an implementation of a Universal Serial Bus (USB) architecture which supports communication between a USB host and a plurality of USB devices.

It is a yet another object of the present invention to provide novel software configuration application executable on a processor of a host computer which facilitates efficient communication between a plurality of USB peripheral devices, which can include printers, monitors, or any other device, attached to a host computer and application programs executing on the processor of the host computer without noticeable bandwidth degradation across the plurality of peripheral devices.

According to one embodiment of the present invention, a software configuration program presents a graphical user interface through which a user can a) designate a plurality of USB-compatible devices to communicate concurrently with the host computer and b) designate one of the plurality of USB compatible devices as the “primary device” and the rest of the plurality of USB compatible devices as the “secondary devices”. The host communicates with the primary USB compatible device in a standard manner. The host communicates with the secondary USB devices and instructs the secondary USB devices to snoop the unique address of the primary USB device, in addition to the unique address of the secondary device itself. The host utilizes vendor-specific constructs to command the plurality of secondary USB devices to store the address of the primary USB device apart from the unique address of the secondary USB device itself.

In accordance with another aspect of the present invention a device driver, in data communication with the configuration application, instructs a secondary USB device to accept data packets related to not only its own unique address but also of at least one other primary USB device whose address was additionally caused to be stored with the USB device.

In accordance with a yet another aspect of the present invention when a data packet is sent from the host addressed to a primary USB device, the primary USB device acts as the active device with respect to responding and acknowledging receipt of the packet. The secondary USB devices act as passive devices in that they are only able to receive the data packet and are not able to respond or acknowledge the receipt of the packet. To account for the concurrent communication between a host and active and passive devices, the present invention further comprises unique approaches to handling errors in data packet communications.

In one embodiment, the present invention is a method of concurrently transmitting data from a host to multiple USB devices, comprising the steps of selecting a primary USB device and a plurality of secondary USB devices, communicating an address of said primary USB device to a device driver for each of said plurality of secondary USB devices, having said device drivers instruct each of said plurality of secondary USB devices to monitor and utilize data sent to said address of the primary USB device, and resending data in response to an error experienced by said primary USB device. In one embodiment, the multiple USB devices are monitors.

Optionally, the device drivers instruct each of said plurality of secondary USB devices to monitor and utilize data sent to said address of the primary USB device by using a vendor specific request. Optionally, each of said secondary USB devices store the address of the primary USB device in a hardware register. Optionally, when a data packet is received by each secondary USB device, the secondary USB device compares the data packet's address field with both an address assigned to said secondary USB device and the address of the primary USB device.

Optionally, the secondary USB device keeps the data packet if the data packet's address field matches either the address assigned to said secondary USB device or the address of the primary USB device. Optionally, the secondary USB device discards the data packet if the data packet's address field does not matches either the address assigned to said secondary USB device or the address of the primary USB device. Optionally, for at least some of the data packets sent by the host, the primary USB device responds with an acknowledgement to indicate to the host that the packet has been properly received by the primary USB device. Optionally, for all of the data packets sent by the host, the secondary USB device does not respond with an acknowledgement to indicate to the host that the packet has been properly received by the secondary USB device.

In another embodiment, the present invention is directed to a method of broadcasting data from a host to at least two USB devices, comprising the steps of selecting a primary USB device and at least one secondary USB device, communicating an address of said primary USB device to a device driver for said at least one secondary USB device, having said device drivers instruct each of said plurality of secondary USB devices to monitor and utilize data sent to said address of the primary USB device by using a vendor specific request, and transmitting data to the address of the primary USB device only and not transmitting the same data to the address of the secondary USB device. Optionally, the host resends data in response to an error experienced by said primary USB device. Optionally, the host does not resend data in response to an error experienced by said at least one secondary USB device.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 shows a block diagram of an exemplary USB system;

FIG. 2 shows a flow chart of conventional enumeration (device recognition) processing in a USB system;

FIG. 3 is a block diagram that shows a software configuration application of the present invention in communication with device drivers of primary and secondary USB devices;

FIG. 4 depicts a flow chart related to a set of secondary USB devices receiving and accepting data addressed to another primary USB device; and

FIG. 5 depicts in a graphical user interface for a program through which a user can identify connected USB devices and select primary and secondary USB devices.

### DETAILED DESCRIPTION OF THE INVENTION

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended.

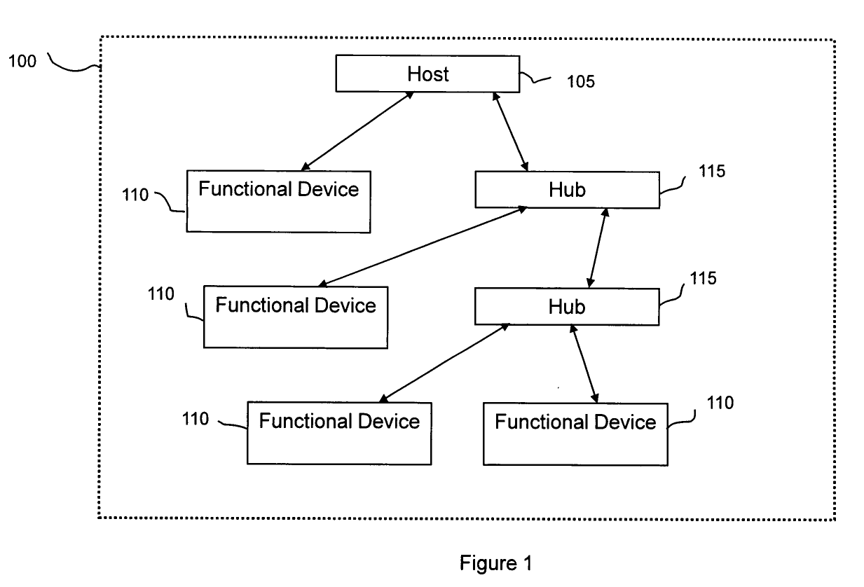

FIG. 1 shows a block diagram of an exemplary USB system 100 comprising a host 105 (hereinafter referred to as the ‘host’) positioned at a root of a typical tree-shaped USB topology (hereinafter referred to as the ‘device tree’). The host is a computer or a computer equivalent having a processing unit. This computer equivalent could include cell phones, personal data assistants, mini computers, main frames, personal computers, distributed computing systems, networks, laptops, desktops, or combinations thereof. The host 105 comprises USB circuitry, including a USB host controller, (not shown) as described in the “Universal Serial Bus Specification” (Rev. 2.0, Apr. 27, 2000), which is published by Compaq, HP, Intel, Lucent, Microsoft, NEC and Philips, and is incorporated herein by reference. The host also runs an operating system such as the Windows OS from Microsoft, Unix, Linux, Mac OS from Apple, or any other operating system which supports the USB architecture as specified in the “Universal Serial Bus Specification”.

The host 105 recognizes a USB peripheral device 110 (hereinafter referred to as the ‘device’) existing at a terminal point of the device tree and transmits/receives data to/from the device 110 on a one-to-one basis. USB devices are classified into two categories, one is “hub device” that provides the USB with new connection points, and the other is “function device” that serves as the peripheral of the system, namely a mouse, a keyboard, a monitor and a printer for instance. FIG. 1 shows hubs 115 positioned at nodes of the device tree which perform functions such as relaying a packet transmission from the upstream (on the host side) to the downstream (on the device side), and from the downstream to the upstream, and detecting connection/disconnection to/from a device located at a downstream node/terminal point. Thus, a USB device 110 can be directly coupled to the host 105 or connected to the downstream of the hub 115. The hub 115 can also be directly coupled to the host 105 or connected downstream to the hub 115 in a manner similar to a general device 110. The relationship between the host 105 and the device 110 in the USB connection is asymmetric. In other words, all communications are started by the host 105, and the device 110 responds to a communication started by the host 105. Therefore, communication packets from the host 105 to the device 110 are sent across the entire tree device through the hub 115. A one-to-one virtual communication path between the host 105 and a device 110 on the USB is referred to as a “pipe”.

The USB device also includes an endpoint structure, and in the USB device, each endpoint is an independent division that acts as the data output or reception terminal during the data transmission between the USB host and the device. Each USB device may possess a set of endpoints adapted for various data transmission characteristics. The endpoints are categorized into control, bulk, interrupt, and isochronous endpoints. Except for control endpoints, which allow two-direction data transmission, the rest are further divided into input and output endpoints.

USB devices possess a set of maximum sixteen endpoints which are used to implement device functions, and each endpoint is assigned with a unique number called “endpoint number”. Therefore, the combination of device address, endpoint number and data transmission direction (output or input) enables the endpoint to acquire a unique and specific address on USB Bus.

Referring back to FIG. 1, the host 105 also comprises device driver software that communicate with the USB devices 110, 115 via USB function interface programs that enable the execution of one or more device functions. Each USB device 110, 115 requires a corresponding function program within the host 105 for the purpose of executing the function provided by the device 110, 115 in the system 100. In order to provide the convenience of USB plug-and-play function, several function device drivers that are commonly used are typically already embedded in the operating system. Hence, when the device 110, 115 is connected to the USB bus, the system 100 can find the embedded software and execute the functions thereof without additional software installation, thus making the USB easier to use.

When the USB device 110, 115 (a hub or a function device) is connected to the USB bus, the USB host 105 executes an enumeration process wherein the host 105 assigns a single unique address to the device 110, 115 and then the USB host 105 communicates with the USB device 110, 115 according to the single unique address. Each USB device 110, 115 therefore has only one unique address to which a host 105 can communicate.

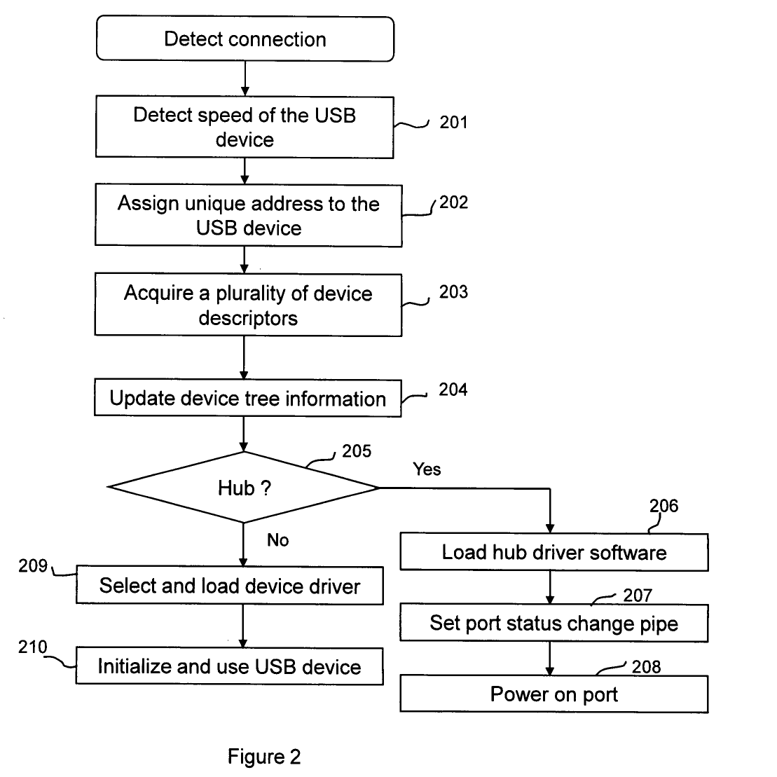

FIG. 2 shows a flow chart of a typical enumeration (device recognition) processing. The enumeration begins with detection of devices connected to hub ports (including the port of the host) which have been powered on. A device connection at a downstream hub is detected through the hub status change pipe. Upon receipt of a reset signal from the upstream, a device starts up with a default address (address 0) being regarded as destined to itself, and is assigned a unique device address by a control command sent from the host to operate subsequently.

Specifically, the host detects a device speed at step 201, and assigns an address to the device at step 202. The host typically records information related to each of devices in a tree shape corresponding to the bus topology in preparation for post-processing. Recorded information includes information for calling driver software for software-based post-processing, in addition to a ‘descriptor’ for acquiring a device.

USB device information is typically stored in ‘descriptors’ or request codes that are data structures formatted as specified by the USB specification. Descriptors are used in a USB system to define ‘device requests’ from a host to a peripheral device. A device request is a data structure that is conveyed in a ‘control transfer’ from the host to the peripheral device. A control transfer contains the following fields in accordance with the USB protocol:

bmRequestType—a mask field indicating (a) the direction of data transfer in a subsequent phase of the control transfer; (b) a request type (standard, class, vendor, or reserved); and (c) a recipient (device, interface, endpoint, or other). The primary types of requests specified in the “request type” field are the “standard” and “vendor” types.

bRequest—a request code indicating one of a plurality of different commands to which the device is responsive.

wValue—a field that varies according to the request specified by bRequest.

wIndex—a field that varies according to request; typically used to pass an index or offset as part of the specified request.

wLength—number of bytes to transfer if there is a subsequent data stage.

All USB devices are supposed to support and respond to “standard” requests—referred to herein as “USB-specific” requests. In USB-specific requests, the request type portion of the bmRequestType field contains a predefined value indicative of the “standard” request type.

Each different USB-specific request has a pre-assigned USB-specific request code, defined in the USB specification. This is the value used in the bRequest field of the device request, to differentiate between different USB-specific requests. For each USB-specific request code, the USB specification sets forth the meanings of wValue and wIndex, as well as the format of any returned data.

Thus, in a typical USB communication, the host typically performs an action of sending a GET_DESCRIPTOR device request to the peripheral device. The GET_DESCRIPTOR device request is a standard, USB-specific request, identified in a control transfer by the GET_DESCRIPTOR request code (bRequest=GET_DESCRIPTOR).

Persons of ordinary skill in the art would appreciate that Chapter 9 of the “Universal Serial Bus Specification” (Rev. 2.0, Apr. 27, 2000) defines standard, device class, and vendor-specific requests that can be used to manipulate a device's state. Descriptors are also defined that can be used to contain different information on the device. Control transfers provide the transport mechanism to access device descriptors and make requests of a device to manipulate its behavior.

Referring back to FIG. 2, as the host acquires a variety of descriptors at step 203, the host updates device tree information at step 204. Then, the host determines whether a hub or a device is connected at step 205. When a hub is connected, the host loads a hub driver at step 206, sets a port status change pipe at step 207, and powers on the associated hub port at step 208. On the other hand, when the host determines that a device is connected, the host selects and loads a device driver at step 209, and initializes the device for using the device at step 210.

One limitation of having a single unique address per device is that if the PC host has the same data to be sent to two different devices, the host must send the data to each device individually. This approach enables each device to independently acknowledge receipt of the packet, thereby enabling a reliable transport protocol. Unfortunately, this comes at a cost of bandwidth utilization, since the data is transmitted twice across the same medium. Therefore, if one host is communicating with a plurality of devices, there is substantial degradation across the various devices.

Given the topology of a USB system, all packets are electrically transmitted over the bus, and can be visible to all devices on the USB. Therefore, USB device hardware is responsible for filtering out packets that are not addressed to the device's address. This is typically done with a hardware register, whereby when the host assigns the USB device an address, this address is stored in a hardware register. When a packet is received by the device, the address of the packet is compared with the stored address. If there is a match, the packet is allowed to proceed, however, if the address does not match, the packet is flushed from the hardware.

For devices of similar type, where the data to be received from the host is identical, the present invention solves the aforementioned problem arising from unique device addressing by enabling a USB device to receive data which is addressed to another USB device. In one embodiment, the present invention accomplishes this by utilizing a USB Specification construct known as a Vendor-Specific Command.

USB devices optionally support “vendor-specific” requests. In a vendor-specific request, the request type portion of the bmRequestType field contains a predefined value to indicate a “vendor” request type. In the case of vendor-specific requests, the USB specification does not assign request codes, define the meanings of wValue and wIndex, or define the format of returned data. Rather, each device has nearly complete control over the meaning, functionality, and data format of vendor-specific requests. Specifically, the vendor can define his own requests and assign vendor-specified request codes to them. The present invention uses this feature in a novel manner, as further described below.

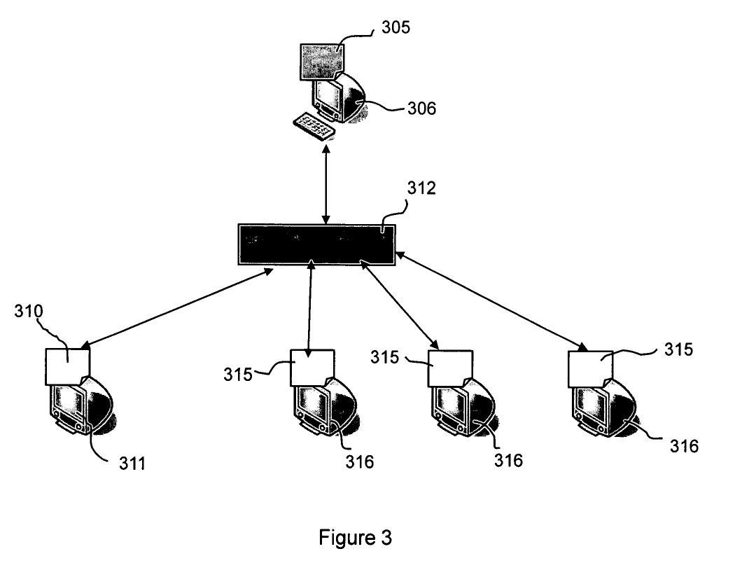

The present invention also comprises a software configuration application that presents a graphical user interface to enable a user to select a plurality of USB devices to which a host may broadcast. FIG. 3 is a block diagram that shows the software configuration application 305, installed on the host 306, in communication with a device driver 310 for a primary USB device 311 via hub 312. The application 305 is also in communication with a plurality of device drivers 315 corresponding to secondary USB devices 316 of the same class as the primary USB device 311. For example, the primary USB device 311 can be a PC monitor from a certain manufacturer and the secondary USB devices 316 can be additional PC monitors which may be identical to the primary monitor, but also may be from different manufacturers and present on the USB tree at different end node points; similarly, the primary USB device 311 can be a mouse or printer and the secondary USB devices 316 can also be a plurality of mouse or printer devices from the same or different manufacturers. The application 305 provides a plurality of configuration options to a user to enable data packets sent by the host 306 to the address of the primary USB device 311 to be also accepted by the secondary devices 316.

In one embodiment the application 305 presents a Graphical User Interface (GUI) that displays, in one example, the following information to the user:
1. A list of all USB devices in communication with the host, grouped in accordance with the device class in one example. Thus, all monitors are identified and displayed to the user under a grouping of ‘monitors’; all memory-sticks are identified and displayed to the user under a grouping of ‘Additional Memory’ and so on depending upon the different types of USB devices in communication with the host 306 at any given time.
2. Allows the user to indicate which USB device in a particular group should be considered as a primary USB device. Thus, the user may select monitor “Monitor 1” as the primary USB device in the ‘monitors’ group.
3. Prompts the user to indicate if he would like data sent to the primary USB device to also be received and displayed by other monitors (referred to as secondary USB devices). The users in one embodiment can also select if all or only certain specific secondary USB devices should receive and display data packets otherwise addressed to the primary USB device.

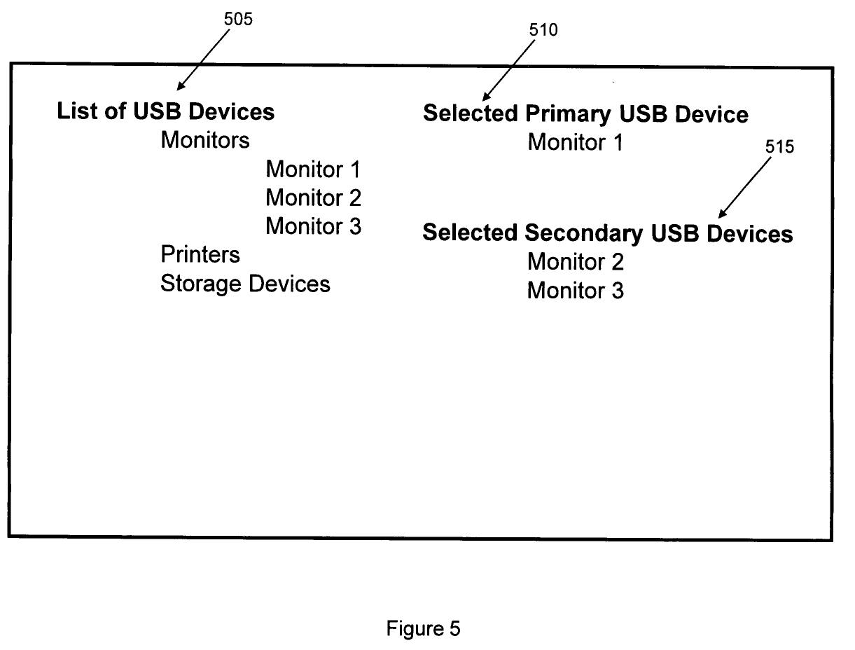

Referring to FIG. 5, an exemplary interface 500 to the program, stored in a storage medium, is depicted. The interface 500 permits a user to identify a list of USB devices 505 by clicking on a “list icon” that communicates with a host and requests a list of enumerated USB devices from the host. The enumerated list 505 is then presented to the user. The interface 500 also enables a user to select a primary USB device, in one embodiment, by clicking on one of the enumerated devices from the list 505, and enables a user to select a secondary USB device, again, in one embodiment, by clicking on one of the enumerated devices from the list 505. The list of primary 510 and secondary 515 USB devices are presented in the interface 500. The identity of the selected primary and secondary USB devices are communicated to the host.

The host communicates with the primary and secondary USB device drivers and instructs the secondary USB device drivers to not flush data which is addressed to the primary USB device. If the user opts for data packets addressed to the primary USB device to be also received and displayed by any or all of the secondary USB devices, the application informs the device driver(s) corresponding to the secondary USB devices to also accept data packets addressed to the primary USB device. Thus, in the current example the configuration application 305 provides the address of the primary monitor Monitor 1 to the device drivers of the secondary monitors informing that the secondary monitors should accept and display data packets sent by the host not only related to their own unique addresses but also related to the address of the primary monitor Monitor 1.

The device drivers corresponding to the secondary USB devices in turn use USB specification constructs known as “vendor-specific” commands to instruct the secondary USB devices to store, in their registers, the address of the primary USB device in addition to their own unique address. When a data packet is received from the host 306, the secondary USB device hardware compares the packet's address field with both its assigned address and the address provided by the software driver (via the Vendor Specific Command). If there is a match to either address, the packet is received by the secondary device hardware. This method can be applied to any number of addresses to be stored with the secondary devices.

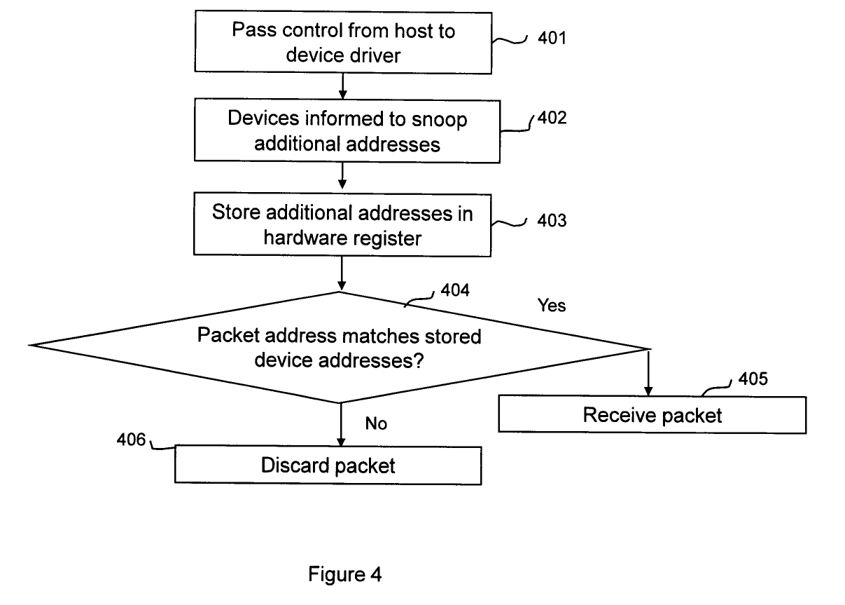

FIG. 4 depicts in a flow chart format the exemplary steps related to a set of USB devices receiving and accepting data addressed to another USB device. Thus, once the initialization phase of the USB device completes, the host passes control of the device to the device's software driver at step 401. Given the host has received the device's descriptors, and from them, can determine the device's class, manufacturer, among other descriptors, the host can transfer control of the device to the software which has registered with the operating system for USB devices with particular characteristics described in the descriptors.

In accordance with the configuration information input by the user, the software configuration application communicates with relevant device drivers that use the ‘vendor specific’ request to inform downstream devices as to which addresses to snoop in addition to their own at step 402. Vendor specific request codes instruct the corresponding devices to store these additional addresses in a hardware register at step 403. When a packet is received, the device hardware can compare at step 404 the packet's address field with both its own assigned address and the addresses provided by the software driver. If there is a match with any of the stored addresses, the packet is received by the device hardware at step 405, or else discarded at step 406. This method can be applied to any number of addresses.

For any packet received from the USB host, the device must respond with an acknowledgement to indicate to the host that the packet has been properly received, or if an error has occurred. Therefore, only the device to which the packet is addressed responds with an acknowledgement. However, a device which is snooping packets addressed to other USB addresses, must not communicate a response or acknowledgement. In that sense, the primary USB device is “active” while the secondary USB devices are “passive”.

The fact that one primary USB device acts as an active device (both listening and responding) and the rest of the secondary USB devices are passive (listening only, not responding), creates unique issues when dealing with errors. As discussed below, there will be times when an error is experienced by a passive secondary device, but not the active primary device, or vice-versa. This causes discontinuities because when a passive secondary device experiences an error related to a packet that it snooped and which was otherwise addressed to the primary device, there is no way to communicate that error to the host and cause the packet to be resent. On the other hand, if the passive secondary device does not experience an error (but the active primary device does), then the passive secondary device cannot stop the host from resending the same packet of data to it again.

The scenarios provided below describe how, in the present invention, errors are dealt with where the standard error handling approach (one device communicating with one host) is not sufficient.

Scenario 1

Device₁ is the active primary device and Devices_{n>1} are passive secondary devices. Both sets of devices detect a CRC error related to a data packet sent by the host. However, only Device₁ responds as per the USB protocol. This is a self correcting scenario because Device1 will respond back with the error, have the host resend, and all devices will get the new data, hopefully with no error.

Scenario 2

If Device₁ detects a CRC error but the Devices_{n>1} had no CRC error, Device₁ will communicate the problem to the host and the host will resend data. The passive secondary devices with no CRC error will also get the new resent data, which is the same as the earlier received data, and see a data toggle error (data toggle used to synchronize data). The Devices_{n>1} that had no error would therefore throw out the newly received data, based on the data toggle error, and wait for the next set, thereby putting all devices in the same state.

Scenario 3

If Device₁ experienced no error while one of the Devices_{n>1} had a CRC error, the host would not know about the error since the passive secondary devices do not acknowledge receipt of the data packet which was actually addressed to the active primary device. In this case, the host moves on and does not resend the packet. The device with the error will get the new data packet and therefore either accept the earlier data with the erroneous data or discard it and move on to the new packet.

Scenario 4

Neither of the Device₁ or Devices_{n>1} experience any error and the host moves on.

The present invention is applicable to any host device broadcasting data to multiple USB devices. The above examples are merely illustrative of the many applications of the methods of the present invention. Although only a few embodiments of the present invention have been described herein, it should be understood that the present invention might be embodied in many other specific forms without departing from the spirit or scope of the invention. For example, while the methods above are directed towards the broadcasting and concurrent display of data on multiple monitors, it can apply to any set of USB devices, including printers, hard drives, or any other output device.

We claim:

1. A method of concurrently transmitting data from a host to multiple USB devices, comprising the steps of:
a. Selecting a primary USB device and a plurality of secondary USB devices;
b. Communicating an address of said primary USB device to a device driver for each of said plurality of secondary USB devices; and
c. Having said device drivers instruct each of said plurality of secondary USB devices to monitor and utilize data sent to said address of the primary USB device.

2. The method of claim 1 wherein the host resends data in response to an error experienced by said primary USB device.

3. The method of claim 1 wherein said multiple USB devices are monitors.

4. The method of claim 1 wherein said device drivers instruct each of said plurality of secondary USB devices to monitor and utilize data sent to said address of the primary USB device by using a vendor specific request.

5. The method of claim 1 wherein each of said secondary USB devices store the address of the primary USB device in a hardware register.

6. The method of claim 4 wherein, when a data packet is received by each secondary USB device, the secondary USB device compares the data packet's address field with both an address assigned to said secondary USB device and the address of the primary USB device.

7. The method of claim 5 wherein said secondary USB device keeps the data packet if the data packet's address field matches either the address assigned to said secondary USB device or the address of the primary USB device.

8. The method of claim 5 wherein said secondary USB device discards the data packet if the data packet's address field does not matches either the address assigned to said secondary USB device or the address of the primary USB device.

9. The method of claim 1 wherein, for at least some of the data packets sent by the host, the primary USB device responds with an acknowledgement to indicate to the host that the packet has been properly received by the primary USB device.

10. The method of claim 8 wherein, for all of the data packets sent by the host, the secondary USB device does not respond with an acknowledgement to indicate to the host that the packet has been properly received by the secondary USB device.

11. A method of broadcasting data from a host to at least two USB devices, comprising the steps of:
a. Selecting a primary USB device and at least one secondary USB device;
b. Communicating an address of said primary USB device to a device driver for said at least one secondary USB device;
c. Having said device drivers instruct each of said plurality of secondary USB devices to monitor and utilize data sent to said address of the primary USB device by using a vendor specific request; and
d. Transmitting data to the address of the primary USB device only and not transmitting the same data to the address of the secondary USB device.

12. The method of claim 10 wherein said multiple USB devices are monitors.

13. The method of claim 10 wherein said host resends data in response to an error experienced by said primary USB device.

14. The method of claim 10 wherein said host does not resend data in response to an error experienced by said at least one secondary USB device.

15. The method of claim 10 wherein each of said secondary USB devices store the address of the primary USB device in a hardware register.

16. The method of claim 14 wherein, when a data packet is received by the at least one secondary USB device, the secondary USB device compares the data packet's address field with both an address assigned to said secondary USB device and the address of the primary USB device.

17. The method of claim 15 wherein said secondary USB device keeps the data packet if the data packet's address field matches either the address assigned to said secondary USB device or the address of the primary USB device.

18. The method of claim 15 wherein said secondary USB device discards the data packet if the data packet's address field does not matches either the address assigned to said secondary USB device or the address of the primary USB device.

19. The method of claim 10 wherein, for at least some of the data packets sent by the host, the primary USB device responds with an acknowledgement to indicate to the host that the packet has been properly received by the primary USB device.

20. The method of claim 18 wherein, for all of the data packets sent by the host, the secondary USB device does not respond with an acknowledgement to indicate to the host that the packet has been properly received by the secondary USB device.
